(19) United States
(12) Patent Application Publication
(10) Pub. No.: US 2009/0194055 A1
(43) Pub. Date: Aug. 6, 2009

(54) VARIABLE INTAKE APPARATUS FOR INTERNAL COMBUSTION ENGINE

(75) Inventors: Hironori Kitadani, Nishikamo-gun (JP); Shigeo Takeuchi, Toyota-shi (JP); Shinji Iwata, Obu-shi (JP)

Correspondence Address: OLIFF & BERRIDGE, PLC, P.O. BOX 320850, ALEXANDRIA, VA, 22320-4850, US

(73) Assignees: Toyota Jidosha Kabushiki Kaisha, Toyota-shi (JP); Aisan Kogyo Kabushiki Kaisha, Obu-shi (JP)

(21) Appl. No.: 12/309,859

(22) PCT Filed: Aug. 6, 2007
(86) PCT No.: PCT/IB2007/002253

§ 371 Date: Feb. 2, 2009

(30) Foreign Application Priority Data
Aug. 7, 2006 (JP) 2006-214386

(51) Int. Cl. F02M 35/10

(52) U.S. Cl. 123/184.55

(57) ABSTRACT

In a variable intake apparatus for an internal combustion engine, each of a plurality of intake pipes is separated from a surge tank by a partition wall, and communication ports, provided in the partition wall for the respective intake pipes, are opened and closed by respective variable intake valves to adjust length of intake passages. In a valve housing that retains the variable intake valves, a first rib is formed in an area between each pair of the variable intake valves, in which a turning shaft is disposed and inserted. The first rib is formed in parallel with the turning shaft. The valve housing includes a fastening portion that is used to fasten the valve housing to an upper cover with a bolt. A second rib is formed in an area that is close to one of the communication ports that is close to the fastening portion.

### BACKGROUND OF THE INVENTION

1. Field of the Invention

The invention relates to a variable intake apparatus for an internal combustion engine. More specifically, the invention relates to a valve housing that retains a plurality of valves provided in a variable intake apparatus.

2. Description of the Related Art

For example, Japanese Patent Application Publication No. 2001-303960 (JP-A-2001-303960) describes a variable intake apparatus for an internal combustion engine, in which each of intake pipes is separated from a surge tank by a partition wall, and communication ports, provided in the partition wall for the respective intake pipes, are opened and closed by respective variable intake valves to adjust the length of intake passages.

In such a variable intake apparatus, a valve housing is provided to maintain the adjustable intake valves. The valve housing is fastened into an upper cover that forms the upper portions of the intake pipes of an intake manifold.

The valve housing is generally made of metal to ensure the rigidity. The intake manifold is generally made of resin to reduce the weight.

However, in the above-described variable intake apparatus, the rigidity of the intake manifold made of resin is lower than the rigidity of the valve housing made of metal. Also, the dimension accuracy generally varies among the intake manifolds made of resin. Therefore, when the valve housing made of metal is fitted to the upper cover that constitutes a part of the intake manifold made of resin, and both of the valve housing and the upper cover are fastened to each other, the upper cover made of resin is greatly distorted due to the high rigidity of the valve housing. As a result, the upper cover may be separated from the valve housing, and accordingly, the gasket provided between the valve housing and the upper cover may be separated from the valve housing and the upper cover. This may deteriorate the level of adhesion between the valve housing and the upper cover. Also, excessive stress may be applied to the valve housing.

### SUMMARY OF THE INVENTION

The invention provides a variable intake apparatus for an internal combustion engine, which makes it possible to prevent separation of an upper cover from a valve housing when the valve housing is fastened to the upper cover, thereby appropriately fitting the valve housing to the upper cover, while ensuring necessary rigidity of the valve housing, and accuracy of installing each variable intake valve.

An aspect of the invention relates to a variable intake apparatus for an internal combustion engine, in which each of a plurality of intake pipes is separated from a surge tank by a partition wall, and communication ports, provided in the partition wall for the respective intake pipes, are opened and closed by respective variable intake valves to adjust length of intake passages. The variable intake apparatus includes a valve housing that retains the variable intake valves; and a turning shaft that is retained by the valve housing, and that axially supports the variable intake valves. In the variable intake apparatus, the variable intake valves are disposed along the turning shaft; and a first rib is formed in an area between each pair of the adjacent variable intake valves.

Because the rib is formed in the area between each pair of adjacent variable intake valves, and the turning shaft extends through the area, it is possible to ensure appropriate accuracy of installing each variable intake valve connected to the turning shaft, and to suppress deformation of the turning shaft, thereby reducing sliding resistance.

In the variable intake apparatus for an internal combustion engine according to the above-described aspect, the first rib may be formed in parallel with the turning shaft. Also, a plurality of first ribs may be formed in a valve housing in which a plurality of turning shafts is provided.

In the variable intake apparatus for an internal combustion engine according to the above-described aspect, the first rib may be formed near the turning shaft such that the first rib extends along the turning shaft.

In the variable intake apparatus for an internal combustion engine according to the above-described aspect, the turning shaft may include two turning shafts that are substantially parallel with each other. The variable intake valves may be axially supported by the two turning shafts, and may be disposed along the two turning shafts. The variable intake valves may be disposed along one of the two turning shafts are offset from the variable intake valves disposed along the other of the two turning shafts in a direction where the two turning shafts extend.

In the variable intake apparatus for an internal combustion engine according to the above-described aspect, a fastening portion may be provided in the valve housing, and the fastening portion may be used to fasten the valve housing to an upper cover that constitutes a part of an intake manifold. A second rib may be formed in an area of the valve housing, which is close to one of the communication ports that is close to the fastening portion.

By additionally disposing another rib in the area of the valve housing, which is close to one of the communication ports that is close to the fastening portion, both of the ribs prevent separation of the upper cover from the valve housing when the valve housing and the upper cover are fastened to each other.

According to the invention, by forming the rib in parallel with the turning shaft, it is possible to ensure appropriate accuracy of installing the variable intake valves connected to the turning shaft, and to suppress deformation of the turning shaft, thereby reducing the sliding resistance. Also, by additionally disposing another rib in the area of the valve housing, which is close to one of the communication ports that is close to the fastening portion, it is possible to prevent separation of the upper cover from the valve housing when the valve housing is fastened to the upper cover, and to fit the valve housing and the upper cover to each other while a gasket, provided between the housing and the upper cover, appropriately contacts the valve housing and the upper cover.

### BRIEF DESCRIPTION OF THE DRAWINGS

The foregoing and/or further objects, features and advantages of the invention will become more apparent from the following description of example embodiments with reference to the accompanying drawings, in which like numerals are used to represent like elements and wherein:

FIG. 1 is a diagram showing the schematic configuration of an intake manifold including a variable intake apparatus for an internal combustion engine according to an embodiment of the invention;

FIG. 2 is a diagram showing the schematic configuration of the intake manifold including the variable intake apparatus for an internal combustion engine according to the embodiment of the invention;

FIG. 3 is a plan view showing a situation where variable intake valves are disposed according to the embodiment of the invention;

FIG. 4 is a bottom view showing the situation where variable intake valves are disposed according to the embodiment of the invention;

FIG. 5 is a diagram showing the configuration of a synchronization link mechanism according to the embodiment of the invention, which is viewed in the direction shown by the arrow Q in FIG. 3;

FIG. 6 is a perspective view showing the synchronization link mechanism when a valve housing is viewed from the bottom surface;

FIG. 7 is a diagram showing the operation of the synchronization link mechanism according to the embodiment of the invention, which is viewed in the direction shown by the arrow Q in FIG. 3;

FIG. 8 is an outline view showing a situation where an actuator is disposed according to the embodiment of the invention when the intake manifold is viewed from the lateral side; and

FIG. 9 is a front view showing a valve housing and an upper cover that are fitted to each other via a gasket according to the embodiment of the invention.

### DETAILED DESCRIPTION OF THE EXAMPLE EMBODIMENTS

Hereinafter, an embodiment of the invention will be described with reference to the drawings.

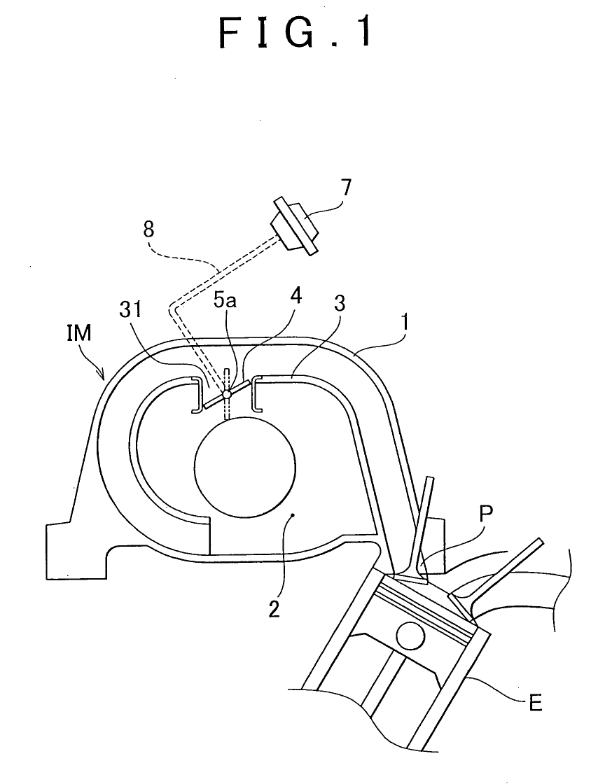

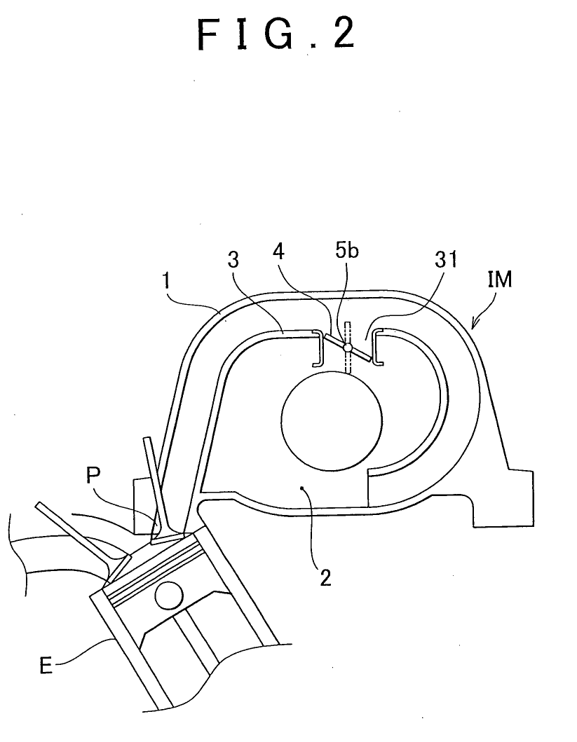

Each of FIG. 1 and FIG. 2 shows the schematic configuration of an intake manifold including a variable intake apparatus for an internal combustion engine according to the embodiment of the invention.

As the internal combustion engine, for example, a V-eight engine is used. The variable intake apparatus according to the embodiment of the invention is applied to the V-eight engine.

The intake manifold IM includes a plurality of intake pipes 1. The number of the intake pipes 1 depends on the number of cylinders of the V-type internal combustion engine. Each of the intake pipes 1 is separated from a surge tank 2 by a partition wall 3. Communication ports 31, provided in the partition wall 3 for the respective intake pipes 1, are opened and closed by respective variable intake valves 4 of the variable intake apparatus to adjust the length of intake passages.

The above-described variable intake valves 4 adjust the length of the intake passages through which air is introduced into intake ports P of the V-type internal combustion engine E from the surge tank 2.

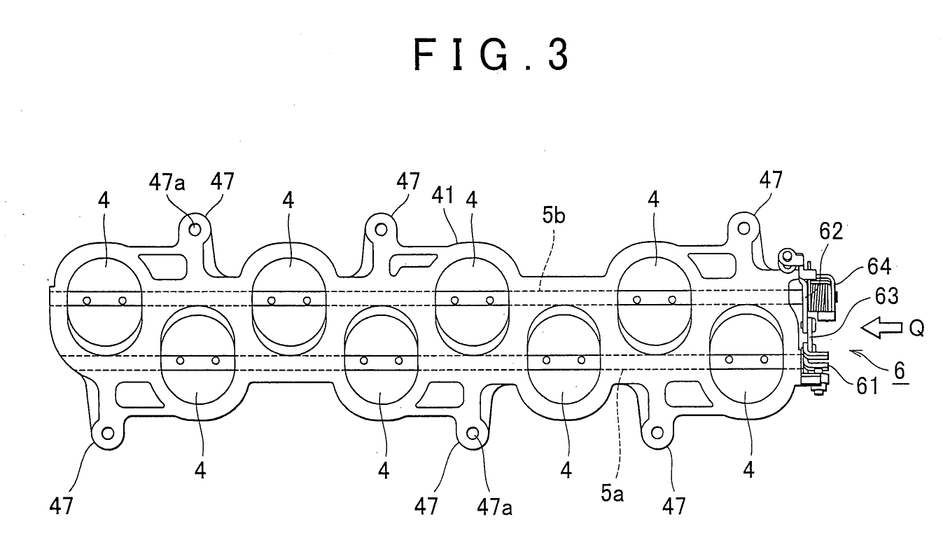

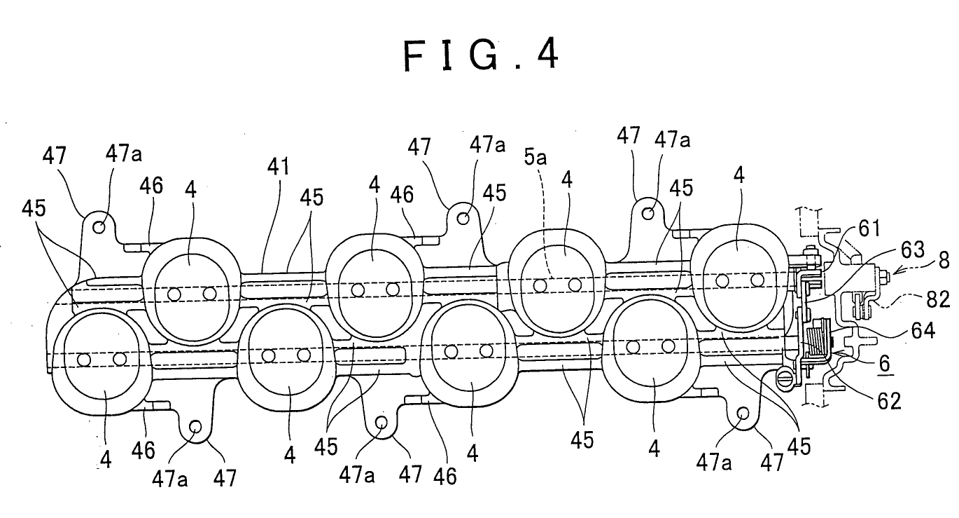

More specifically, when the V-eight engine is used as the internal combustion engine, the eight variable intake valves 4 are provided in a valve housing 41, as shown in FIG. 3 and FIG. 4. That is, the number of the variable intake valves 4 is the same as the number of cylinders. All the variable intake valves 4 are disposed in two parallel rows, that is, the four variable intake valves 4 are disposed in one row, and the four variable intake valves 4 are disposed in the other row. The variable intake valves 4 in one row are offset from the variable intake valves 4 in the other row. That is, in FIG. 1 showing the intake manifold, the variable intake valve 4 disposed in one row is shown. In FIG. 2 showing the intake manifold, the variable intake valve 4 disposed in the other row (the row on the opposite side) is shown. FIG. 3 is a plan view of the valve housing 41 viewed from above. FIG. 4 is a bottom view of the valve housing 41 viewed from below.

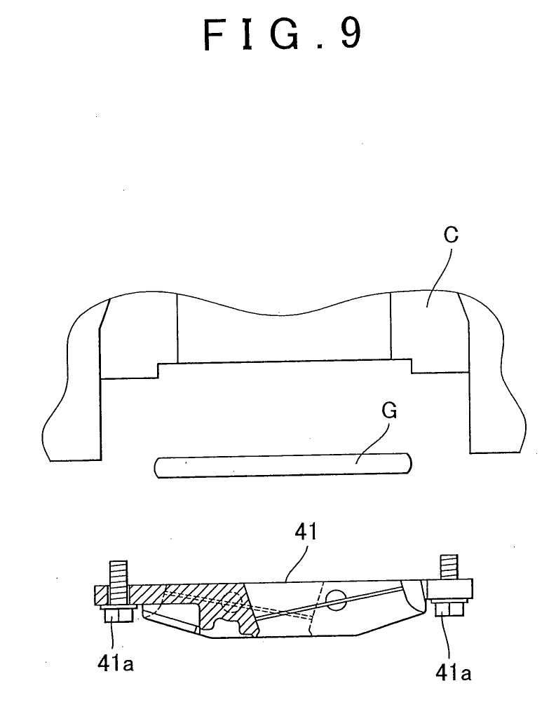

The valve housing 41 is fastened to an upper cover C, which is a constituent component of the intake manifold, via a gasket G using blots 41a, as shown in FIG. 9. The upper cover C forms the upper portions of the intake pipes of the intake manifold IM.

The variable intake valves 4 in the rows are connected to turning shafts 5a and 5b. The turning shafts 5a and 5b are inserted in the valve housing 41 and retained by the valve housing 41.

That is, the variable intake valves 4 are axially supported by the two turning shafts 5a and 5b that are substantially parallel with each other. The variable intake valves 4 disposed along the turning shaft 5a are offset from the variable intake valves 4 disposed along the turning shaft 5b in the direction where the turning shafts 5a and 5b extend. Further, the variable intake valves 4 are connected to the turning shafts 5a and 5b.

One turning shaft 5a is turned by an actuator 7 (described later), and both of the turning shafts 5a and 5b are synchronously turned via a synchronization link mechanism 6. Thus, the variable intake valves 4 are synchronously operated to open and close the communication ports 31.

At low engine speed, the variable intake valves 4 thus disposed increase the length of the intake passages by closing the communication ports 31, as shown by the solid lines in FIG. 1 and FIG. 2. As a result, at low-to-intermediate engine speed, air-intake efficiency is improved due to an intake air inertia effect, and thus the output from the engine is increased.

At high engine speed, the variable intake valves 4 decrease the length of the intake passages by opening the communication ports 31, as shown by the two dot chain lines in FIG. 1 and FIG. 2. As a result, the air-intake efficiency reaches a peak at high engine speed. Thus, the output from the engine is increased at high engine speed.

The turning shaft 5a, which is one of the above-described turning shafts 5a and 5b, is turned by the actuator 7 (described later) to drive the other turning shaft 5b. Thus, the turning shaft 5a will be referred to as “drive-side shaft 5a”, and the other turning shaft 5b will be referred to as “driven-side shaft 5b”.

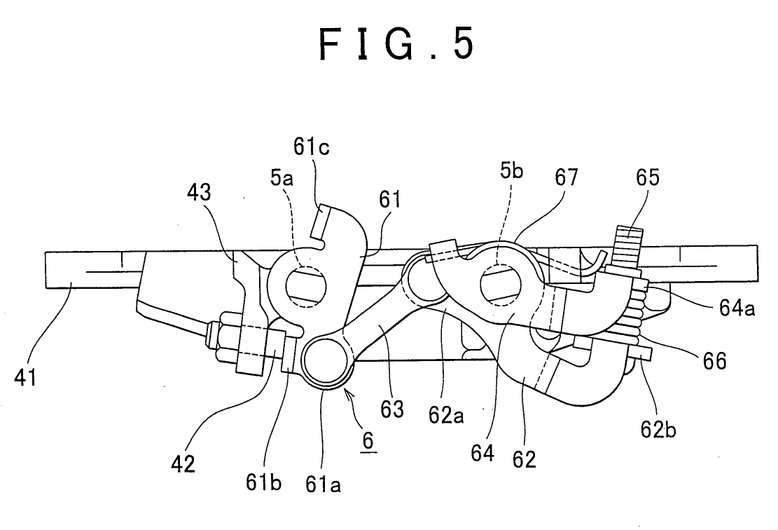

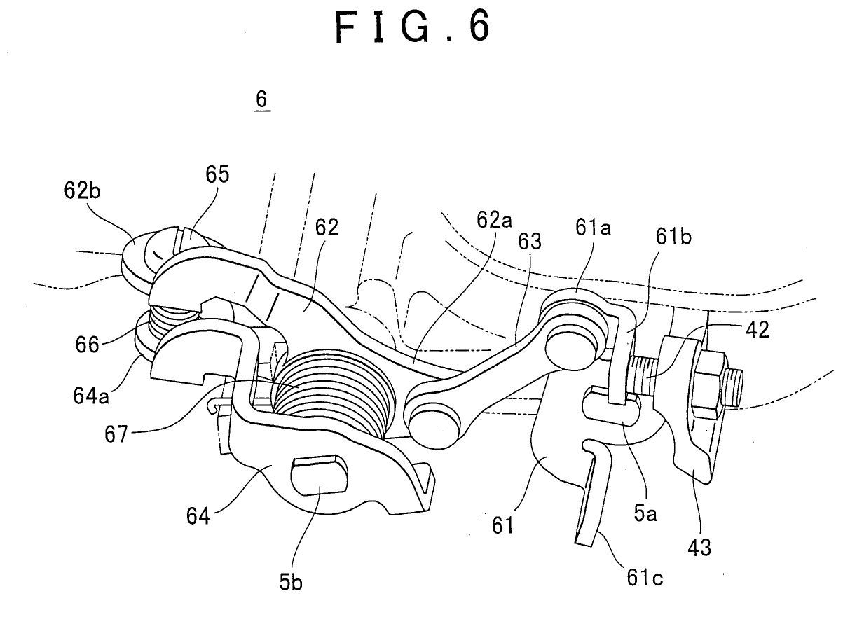

As shown in FIG. 5 and FIG. 6, the synchronization link mechanism 6 is disposed between, and connected to one end portions (right end portions in FIG. 3 and FIG. 4) of the paired drive-side shaft 5a and driven-side shaft 5b. FIG. 5 is a diagram viewed in the direction shown by the arrow Q in FIG. 3. FIG. 6 is a perspective view of the synchronization link mechanism when the valve housing is viewed from the bottom surface-side.

In each of FIG. 5 and FIG. 6, the synchronization link mechanism 6 includes a drive-side operation link 61, a connection-side operation link 62, a connection link 63, and a driven-side operation link 64. A portion of the drive-side operation link 61 is integrally supported by the one end portion of the drive-side shaft 5a. A portion of the connection-side operation link 62 is turnably supported by the one end portion of the driven-side shaft 5b. The connection link 63 is connected to one end portion 61a of the drive-side operation link 61, and one end portion 62a of the connection-side operation link 62. A portion of the driven-side operation link 64 is integrally supported by one end of the driven-side shaft 5b, which is positioned outside the connection-side operation link 62. The other end portion 62b of the connection-side operation link 62 is connected to one end portion 64a of the driven-side operation link 64.

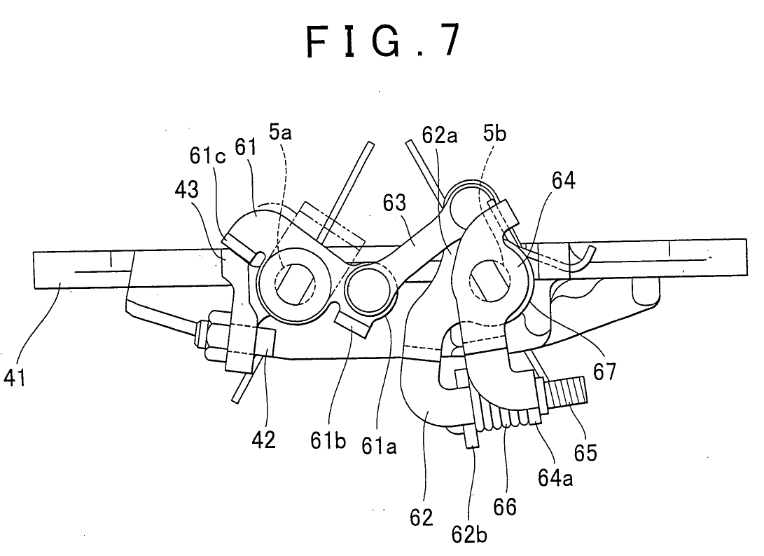

In the drive-side operation link 61, a contact portion 61b is formed in the one end portion 61a, and a contact portion 61c is formed in the other end portion. The contact portion 61b contacts the end of a stopper screw 42 provided in the valve housing 41. The contact portion 61c contacts a stopper portion 43 provided in the valve housing 41. When the contact portion 61b of the drive-side operation link 61 contacts the stopper screw 42, the variable intake valves 4 are placed in the closed positions. When the contact portion 61c of the drive-side operation link 61 contacts the stopper portion 43, the variable intake valves 4 are placed in the open positions (refer to FIG. 7). It should be noted that when the variable intake valves 4 are placed in the closed positions, the communication ports 31 may be fully closed, or may be slightly open due to adjustment of the positions of the stopper screw 42 (first adjusting means) and the screw member 65 (second adjusting means) performed by turning the stopper screw 42 and the screw member 65, respectively. Adjustment of the stopper screw 42 and the screw member 65 will be described later.

The other end portion 62b of the connection-side operation link 62, and the one end portion 64a of the driven-side operation link 64 are disposed at a predetermined interval, and connected to each other by a screw member 65. A spring 66 is disposed between the other end portion 62b of the connection-side operation link 62 and the one end portion 64a of the driven-side operation link 64 such that the spring 66 is fitted to the outer periphery of the screw member 65.

A spring 67 is disposed between the portion of the connection-side operation link 62 and the portion of the driven-side operation link 64 such that the spring 67 is fitted to the outer periphery of the one end portion of the driven-side shaft 5b. The spring 67 presses the driven-side operation link 64 in such a direction that the variable intake valves 4 are placed in the open position, as shown in FIG. 7.

Accordingly, when the synchronization link mechanism 6 is placed in such a state that the variable intake valves 4 are placed in the closed positions as shown in FIG. 5, and then the position of the stopper screw 42 is adjusted by turning the stopper screw 42 to adjust the turning position of the drive-side shaft 5a via the drive-side operation link 61, and to adjust the turning position of the driven-side shaft 5b via the synchronization link mechanism 6, the closed positions (opening degrees) of the variable intake valves 4 are adjusted.

When the synchronization link mechanism 6 is placed in such a state that the variable intake valves 4 are placed in the closed positions as shown in FIG. 5, and then the position of the screw member 65 is adjusted by turning the screw member 65 to change the interval between the other end portion 62b of the connection-side operation link 62 and the one end portion 64a of the driven-side operation link 64, and to adjust the turning position of the driven-side operation link 64 with respect to the turning position of the connection-side operation link 62, the closed position of the variable intake valves 4 connected to the driven-side shaft 5b is adjusted via the driven-side shaft 5b.

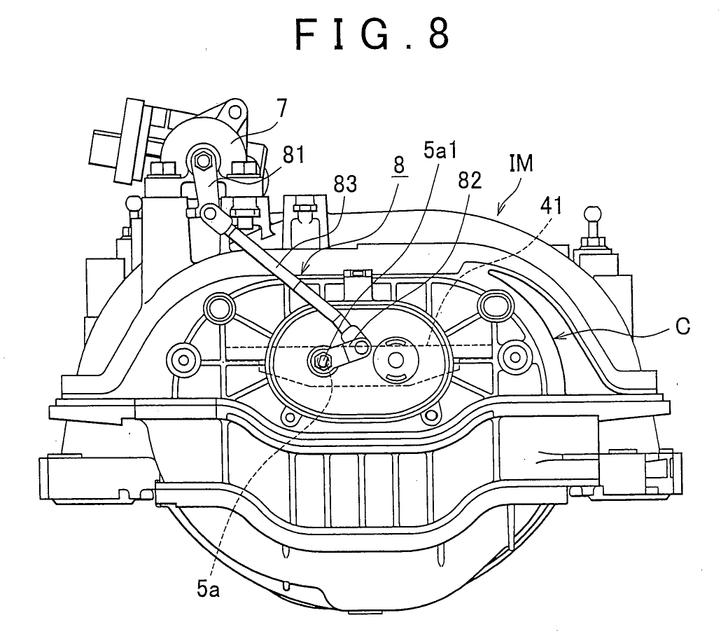

The actuator 7 is connected to the drive-side shaft 5a via coupling means 8 as shown in FIG. 8. When the actuator 7 brings the synchronization link mechanism 6 from the state shown in FIG. 5 to the state shown in FIG. 7 using the force of the spring 67 via the coupling means 8 and the drive-side shaft 5a, the variable intake valves 4 are brought from the closed positions to the open positions.

More specifically, the coupling means 8 includes operation arms 81 and 82, and a connection rod 83. The base end portion of the operation arm 81 is connected to the output shaft of the actuator 7 such as an electric motor. The base end portion of the operation arm 82 is connected to a protrusion portion 5a1 that protrudes from the one end of the drive-side shaft 5a toward the lateral side of the upper cover C. The connection rod 83 connects the end portions of the operation arms 81 and 82. Thus, when the operation arm 81 is turned in the clockwise direction by the actuator 7 in FIG. 8, and the operation arm 82 is turned in the counter clockwise direction via the connection rod 83, the drive-side shaft 5a is turned, and the driven-side shaft 5b is turned via the synchronization link mechanism 6 as described above. Thus, the variable intake valves 4 are brought from the closed positions to the open positions. When the operation arm 81 is turned in the opposite direction, the variable intake valves 4 are brought from the open positions to the closed positions.

All the variable intake valves 4 are disposed in two parallel rows such that the variable intake valves 4 in one row are offset from the variable intake valves 4 in the other row, as described above. Therefore, it is possible to decrease the length in the direction in which the variable intake valves 4 are arranged, as compared to the case where all the variable intake valves arranged in one row. Thus, the size of the variable intake apparatus is reduced, and accordingly, the size of the entire engine is reduced.

Also, the synchronization link mechanism 6 is disposed in a space formed by decreasing the length in the direction in which the variable intake valves 4 are arranged. Further, the turning shafts 5a and 5b are turned by one actuator 7. Thus, with the simple configuration, it is possible to open and close the communication ports 31 by synchronously operating the variable intake valves 4 while maintaining the compact size.

Further, the closed positions of all the variable intake valves 4 are adjusted using the stopper screw 42. Also, the closed position of the variable intake valves 4 in one row is adjusted with respect to the closed position of the variable intake valves 4 in the other row, using the screw member 65. Thus, it is possible to easily and quickly adjust the difference in the closed position caused due to use, and to constantly operate the variable intake apparatus in an appropriate state.

As shown in FIG. 4, a plurality of ribs 45 and 46 is formed on the bottom surface of the valve housing 41. The ribs 45 and 46 constitute the main part of the invention. More specifically, in the valve housing 41, the ribs 45 are formed in an area between each pair of the adjacent variable intake valves 4, and the turning shaft 5a or 5b extends through the area. The ribs 45 are parallel with the turning shafts 5a and 5b. The rib 45 may be regarded as the first rib according to the invention.

A plurality of ribs 45 may be formed in parallel with each of the turning shafts 5a and 5b. Especially, at least one rib 45 may be formed near each of the turning shafts 5a and 5b such that the at least one rib 45 extends along each of the turning shafts 5a and 5b.

Also, fastening portions 47 are formed in the periphery of the valve housing 41. Installation holes 47a are formed in the respective fastening portions 47. The valve housing 41 is fastened to the upper cover C by screwing the bolts 41a into the installation holes 47a. The rib 46 is formed in an area of the valve housing 41, which is close to one of the communication ports 31 that is close to each of the fastening portions 47. The rib 46 may be regarded as the second rib according to the invention.

The valve housing 41 is generally made of metal to ensure the rigidity. The intake manifold IM is generally made of resin to reduce the weight.

Thus, when the valve housing 41 made of metal is fitted to the upper cover C that constitutes a part of the intake manifold IM made of resin, the ribs 45 prevent the deformation of the insertion holes through which the turning shafts 5a and 5b are inserted, due to the fastening force of the bolts 41a. This allows the turning shafts 5a and 5b to smoothly turn. Also, the ribs 46 prevent the deformation of the communication ports 31. This maintains the sealing performance when the variable intake valves 4 are in the closed positions. Thus, the accuracy of installing the variable intake valves 4 is ensured. Further, when the valve housing 41 and the upper cover C are fastened to each other, both of the ribs 45 and 46 prevent the separation of the upper cover C from the valve housing 41 at the area where the gasket G is provided. Thus, the valve housing 41 and the upper cover C are appropriately fitted to each other while the gasket G closely contacts the valve housing 41 and the upper cover C.

That is, the valve housing 41 is appropriately fitted to the upper cover C by providing the ribs 45 and 46 in the main portions that need to have high rigidity while reducing the rigidity of the entire valve housing 41. Also, the weight of the valve housing 41 itself is reduced.

The above-described embodiments are example embodiments of the invention. The invention is not limited to the above-described embodiments. Various modifications may be made to the design in the scope of the invention.

For example, the internal combustion engine is not limited to the V-eight internal combustion engine. Any internal combustion engine, to which the variable intake apparatus according to the invention is applied, may be employed, regardless of the type of the engine or the number of cylinders.

While the invention has been described with reference to exemplary embodiments thereof, it should be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

1.-5. (canceled)

6. A variable intake apparatus for an internal combustion engine, comprising:
a plurality of intake pipes;
a surge tank;
a partition wall that separates each of the intake pipes from the surge tank;
communication ports that are provided in the partition wall for the respective intake pipes, and that provide communication between the respective intake pipes and the surge tank;
variable intake valves that open and close the respective communication ports to adjust length of intake passages;
a valve housing that retains the variable intake valves; and
a turning shaft that is retained by the valve housing, and that axially supports the variable intake valves,
wherein:
the variable intake valves are disposed along the turning shaft; and
a first rib is formed in an area between each pair of adjacent variable intake valves,
wherein a fastening portion is provided in the valve housing, and the fastening portion is used to fasten the valve housing to an upper cover that constitutes a part of an intake manifold; and
a second rib is formed in an area of the valve housing, which is close to one of the communication ports that is close to the fastening portion.

7. The variable intake apparatus for an internal combustion engine according to claim 6, wherein the first rib is formed in parallel with the turning shaft.

8. The variable intake apparatus for an internal combustion engine according to claim 6, wherein the first rib is formed near the turning shaft such that the first rib extends along the turning shaft.

9. The variable intake apparatus for an internal combustion engine according to claim 6, wherein:
the turning shaft includes two turning shafts that are substantially parallel with each other;
the variable intake valves are axially supported by the two turning shafts, and disposed along the two turning shafts; and
the variable intake valves disposed along one of the two turning shafts are offset from the variable intake valves disposed along the other of the two turning shafts in a direction where the two turning shafts extend.
